(19) United States
(12) Patent Application Publication
(10) Pub. No.: US 2002/0036093 A1
(43) Pub. Date: Mar. 28, 2002

(54) Cable Clamp

(76) Inventor: Olaf Johannsen, Sonderborg (DK)

Correspondence Address: WINSTON & STRAWN, 200 PARK AVENUE, NEW YORK, NY, 10166-4193, US

(21) Appl. No.: 09/950,891

(22) Filed: Sep. 12, 2001

Related U.S. Application Data
(63) Continuation of application No. PCT/DK00/0009, filed on Mar. 9, 2000.

(30) Foreign Application Priority Data
Mar. 11, 1999 (DK) PA 1999 00349

(51) Int. Cl. H02G 3/18

(52) U.S. Cl. 174/65 R

(57) ABSTRACT

A cable clamp serving for mounting in an opening in e.g. a wall and enveloping a cable inserted through the opening. The cable clamp comprises a threaded nipple and a threaded socket that when screwed together are defining an axis and defining an axially extending leading-in channel for the cable, an annular gasket placed intermediately in this channel and arranged to be compressed around the cable when the nipple and the socket are screwed together, and a relieving clamp for subsequently clamping the cable in the cable clamp. By means of a lock in form of a radial rib on the nipple and a corresponding radial groove in the socket the cable clamp is locked in the correct screwed-together state in which the connection is given the required tightness. The cable clamp is generally applicable for cables within a predetermined diameter interval, and is secured against damage at assemblage.

### CROSS-REFERENCE TO RELATED APPLICATIONS

This application is a continuation of international application PCT/DK00/00009 filed Mar. 9, 2000, the content of which is expressly incorporated herein by reference thereto.

### BACKGROUND ART

The invention relates to a cable clamp for mounting in an opening in e.g. a wall and enveloping a cable inserted through the opening, or for constituting a component of a cable connector, and of the kind that comprises a threaded nipple and a threaded socket that when screwed together are defining an axis and defining an axially extending leading-in channel for the cable, an annular gasket placed intermediately in this channel and arranged to be compressed tightly around the cable when the nipple and the socket are screwed together, and a relieving clamp for subsequently clamping the cable in the cable clamp, whereby the threaded nipple and the threaded socket each have a spanner head, and the head of the nipple is provided with a transverse groove for receiving the relieving clamp at assemblage.

Such a cable clamp is known from the applicant's Danish patent no. 167991 which is incorporated by reference in the present patent application. The annular gasket in this known cable clamp has a rectangular cross section. However, this form requires that the gasket matches the respective cable well if the connection is to obtain the necessary tightness.

For economic and environmental reasons, products as cable clamps are today reutilized to an increasing extent instead of merely being thrown away as before.

However, if the above known cable clamp is reutilized for a thinner cable than the previous, the connection will now have no or insufficient tightness unless the gasket at the same time is replaced with another that matches the thinner cable.

If the cable clamp on the contrary is to be utilized for a thicker cable, the gasket must also be replaced as the opening in the existing gasket will be too small to allow the thicker cable to pass.

Before such an old cable clamp is taken into use, it is therefore in any case necessary to first check if the gasket which is already in the cable clamp really matches the new cable.

If the gasket does not fit as often will be the case, it is necessary to first completely disassemble the cable clamp in order to thereby be able to replace the mismatched gasket with a properly proportioned one, and then reassemble the cable clamp.

The time-consuming and difficult labor of performing these operations can often animate the operator contrary to the idealistic object of the reutilization idea to use a new gasket or a completely new cable clamp instead of the old one.

Another disadvantage is that it is necessary to have a large and costly stock of gaskets and cable clamps in many different dimensions.

The cable clamp known from the above Danish patent has a relieving clamp with forward projecting arms provided with inward pointing hooks serving for at assemblage engaging with corresponding recesses in the socket and thereby ensuring that the nipple and the socket are screwed sufficiently together to effectively be able to clamp the gasket tightly around the cable.

However, it has proven that it, in display of lack of care on the part of the operator, has been possible to press the relieving clamp in position without its hooks engaging or completely engaging the recesses of the socket at the risk of the arms of the clamp thereby being damaged or broken and of not obtaining the intended tightness.

The object of the above arrangement of the relieving clamp and the corresponding recesses in the socket is as mentioned to ensure that the cable clamp is tightened sufficiently to give the connection the required tightness.

If the cable clamp on the contrary is tightened too much as has often turned out to be the case when the operator uses large spanner for the purpose, there is a risk of the threaded connection being broken as the known cable clamp lacks the means for securing against this sort of damage.

Furthermore, a threaded connection which incidentally is screwed correctly together can be inclined to more or less unscrew itself, for example when the cable gets twisted. In this case the result might be that the gasket of the cable clamp gradually will not fit sufficiently tightly around the cable. The arms of the relieving clamp are too weak to be able to prevent such a progressive process, and they will therefore instead merely yield and possibly be broken.

### SUMMARY OF THE INVENTION

The object of the invention is to provide a cable clamp of the kind mentioned in the opening paragraph that is secured against damage when it is screwed together.

A second object of the invention is to provide a cable clamp of the kind mentioned in the opening paragraph that can be locked in the state in which it is screwed together properly.

A third object of the invention is to provide a cable clamp of the kind mentioned in the opening paragraph that is generally applicable for cables within a predetermined interval of diameters.

The transverse groove leaves according to the invention an end wall situated in the normal plane of the axis on the point where the thread of the nipple begins, and on this end wall is constructed a projection which is extending towards the head of the socket, said head having a recess arranged to finally receive the projection when the nipple is screwed together with the socket.

If the end wall is relatively thin, it will be bent a little in over the transverse groove when the projection butts on the opposite end wall of the socket. This deflection will most easily take place when the projection is placed just opposite the transverse groove.

The deflection of the end wall diminishes the opening of the transverse groove so that it is not possible to push the relieving clamp into the groove before the projection of the nipple snaps into the recess of the socket with a click that normally is audible to the operator.

This structure advantageously corresponds with the design of the relieving clamp of the known cable clamp with two axially forward projecting arms with inward pointing hooks that are to engage with corresponding recesses in the socket head to ensure that the gasket will be clamped sufficiently tight around the cable when the cable clamp is screwed together.

As mentioned above, the screwed-together position that corresponds to this is however only obtained when the projection of the nipple has engaged the corresponding recess of the socket, and until this condition has been satisfied, the operator will therefore not be able to unintentionally press the relieving clamp down into the transverse groove at the risk of thereby both damaging or breaking the arms of the clamp and of the connection not obtaining the required tightness.

In order to avoid incorrect assemblage, the cable clamp can furthermore be constructed in such a way that the inward pointing hooks on the two axially projecting arms of the relieving clamp are only able to engage with corresponding recesses in the socket head in one and only one of the angularities which the nipple and the socket are able to assume in relation to each other.

The structure according to the invention effectively guarantees that the cable clamp always is tightened sufficiently to give the connection the required tightness and at the same time, it also guarantees that the cable clamp is not tightened too much and thereby is damaged or broken.

If the axial extent of the projection corresponds to the lead of the thread, the advantage is obtained in that the respective end faces of the nipple and the socket will abut when the projection engages with the recess, the result of which is that the rigidity and strength of the cable clamp are increased.

The structure is especially effective if the projection of the nipple and the corresponding recess of the socket are designed as a radial rib and a radial groove respectively with a rectangular cross section.

For a rib and a groove of this shape that engage each other act together as a lock for preventing the operator from tightening the cable clamp too hard. At the same time, the lock effectively secures against the cable clamp unintentionally coming loose so that the connection thereby will lose the required tightness.

In locked state, the nipple and the socket can thus not be unscrewed just like that at the disassembling of the cable clamp. For this purpose, there can however in the socket behind the position of the rib in locked position be constructed a notch that allows an e.g. screwdriver getting down to press the nipple out of its engagement with the groove of the socket so that the operator now is able to screw the two parts of the cable clamp apart and thereby disassemble the cable clamp.

The annular gasket can advantageously be arranged in such a way that it can be utilized for cables of a thickness that vary within a predetermined interval.

For this purpose, the gasket can for example be shaped as two opposite facing funnels that pass into each other in the area of their smallest diameter. When the nipple is screwed into the socket, this gasket is deformed in such a way that a central part on its inside is pressed tightly towards a cable which is relatively thin, whereas there along a second central part on the outer side of the gasket is an air-filled space in form of a body of revolution. If the cable on the contrary is relatively thick, the gasket is instead enlarged resulting in a great or small reduction of the volume of the above air-filled space.

### BRIEF DESCRIPTION OF THE DRAWINGS

The invention will be explained in greater detail below, describing only exemplary embodiments with reference to the drawing, in which

FIG. 1 is an exploded, perspective view of a cable clamp according to the invention,

FIG. 2 is a side elevational view of a gasket for the cable clamp in FIG. 1 partly in section,

FIG. 3 is a partly axial sectional view of the cable clamp according to the invention in application with a relatively thin cable,

FIG. 4 is the cable clamp in FIG. 3 in application with a relatively thick cable,

FIG. 5 is an angular-displaced axial sectional view of the cable clamp in FIG. 4 which is not quite screwed together, and

FIG. 6 is the cable clamp in FIG. 4 angularly displaced 90° and completely screwed together.

### DETAILED DESCRIPTION OF PREFERRED EMBODIMENT

FIG. 1 is an exploded view that in perspective shows the components of a cable clamp according to the invention.

Seen in order from left to right in the figure is 1 a threaded nipple having a hexagonal spanner head 2, 3 is a spacer, 4 a gasket made of an elastomer, and 5 a threaded socket having a hexagonal spanner head 6.

In the head 2 of the nipple is constructed a transverse groove 7 for receiving the relieving clamp 8. In the case shown, this clamp has an upper and lower clamp shoe 9 and 10 that match cables (not shown in FIG. 1) of different sizes.

When the relieving clamp 8 is pushed into the transverse groove 7 of the nipple head, it can by means of screws 11 which via smooth-faced holes 12 in the relieving clamp are screwed into corresponding threaded holes 13 in the head 2 of the nipple, clamp a cable in the cable clamp with its lower clamp shoe 10. A not so thick cable is clamped in the same way, but with the relieving clamp turned 180° and its upper clamp shoe 9 resting against the cable.

At each side the relieving clamp 8 has an axially forward projecting arm 14 having an inward pointing hook 15 at the end. On each of two opposite spanner faces of the hexagonal head 6 of the threaded socket 5 are furthermore constructed a radially projecting rib 16.

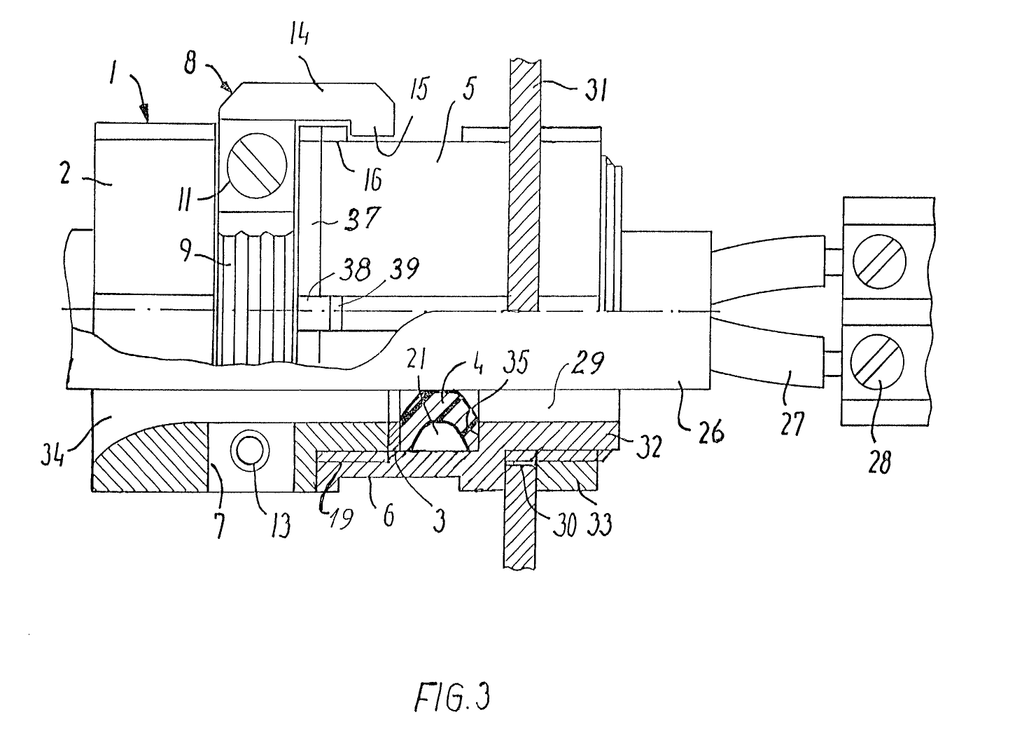

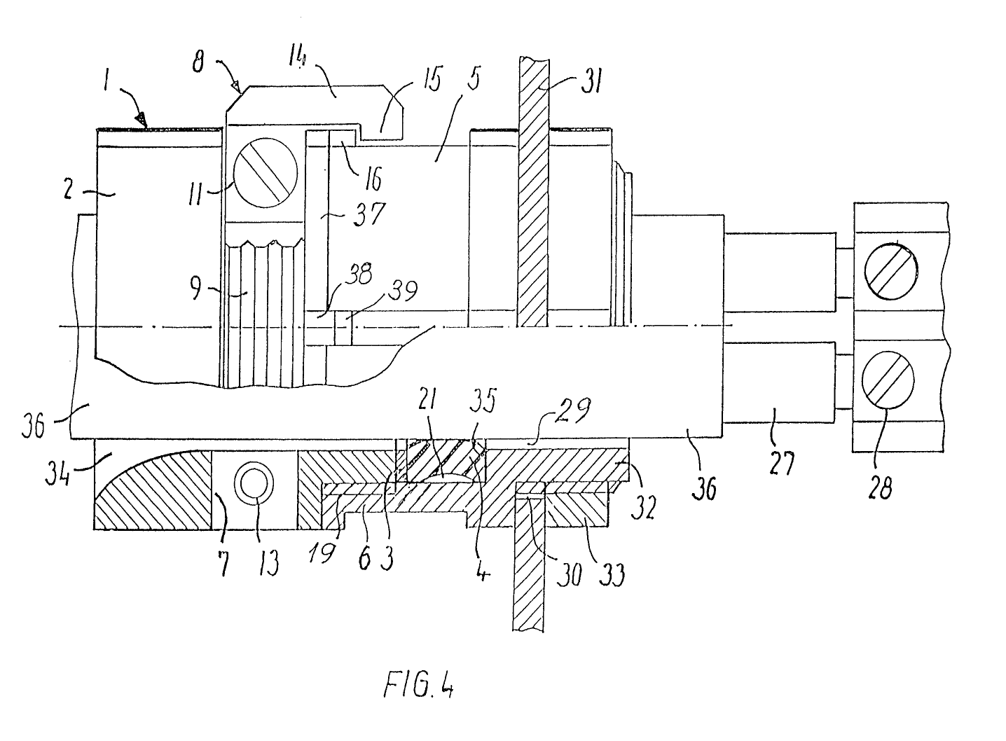

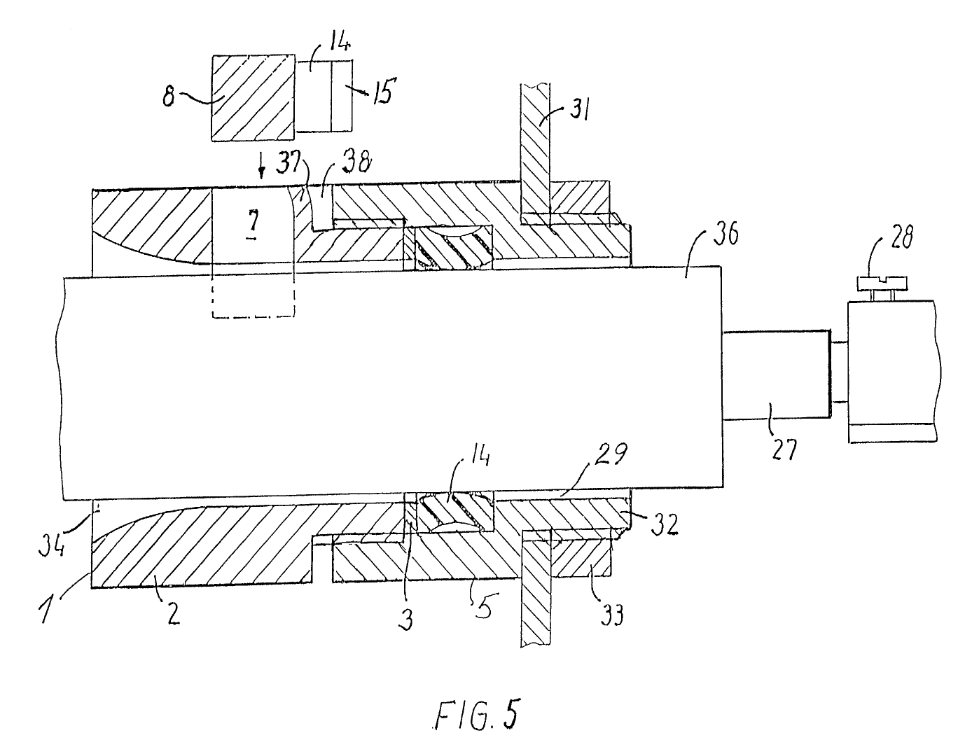

As shown in FIG. 3, the hooks 15 on the forward projecting arms 14 of the relieving clamp 8 are allowed to engage immediately behind these ribs 16 if the cable clamp is screwed together properly, that is in such a way that the connection has obtained the required tightness.

In order to avoid incorrect assemblage, the hexagonal spanner head 6 of the socket is designed with a greater distance between its two other pair of opposite spanner surfaces than the distance between the hooks 15 which therefore only can reach behind the ribs 16 in one and only one screwed-together position, namely the above correct position in which the hooks 15 are exactly gripping behind the ribs 16.

The arms of the relieving clamp with the hooks 15 thus ensure together with the ribs 16 of the socket head that the gasket 4 is always compressed exactly so much when the cable clamp is screwed together that the connection obtains the specified tightness.

The threaded socket 5 has an opening 17 with an internal thread 18, whereas the threaded nipple 1 has an external thread 19 matching the internal thread 18 of the socket.

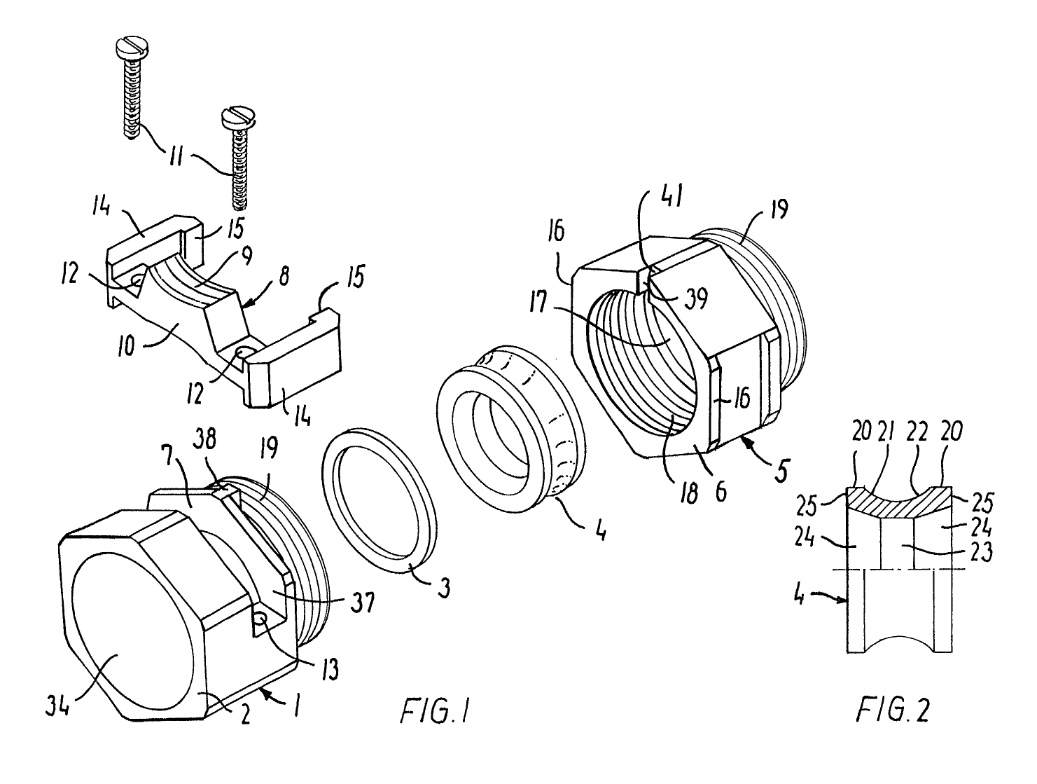

The annular gasket 4 is best seen in FIG. 2. At each end, the gasket has an exterior cylinder face 20 matching a corresponding smooth part in the opening 17 of the threaded socket 5. Between the cylinder faces 20, the gasket 4 has a wide groove 21 having a, seen in cross section, curved bottom 22. Internally, the gasket furthermore has in the center an inner cylinder face 23 passing into conical face section 24 extending to the end faces 25 of the gasket. The gasket is thus mainly shaped as two opposite facing funnels with common smallest opening.

In FIG. 3, the cable clamp in FIG. 1 is assembled around a relatively thin cable 26 having wires 27 connected to terminals 28.

The cable 26 is via an axially extending leading-in channel 29 in the cable clamp inserted through an opening 30 in a wall 31. For this purpose, the socket 5 has a nipple portion 32 clamped in the opening 30 by means of a nut 33.

The mouth 34 of the leading-in channel 29 is at the end of the cable clamp shaped as a funnel in order to thereby allow the cable to be bent on this point without being damaged.

The relieving clamp 8 is pushed into the transverse groove 7 of the nipple head 2 and is by means of the screws 11 screwed down over the cable 26 which thereby is kept clamped in the cable clamp against pull.

In this fully assembled state, the hooks 15 on the arms 14 of the relieving clamp 8 are gripping, as shown, behind the radially extending ribs 16 of the socket head 6 in order to as mentioned above ensure that the gasket 4 is compressed sufficiently for the connection to obtain the necessary tightness.

The gasket 4 which was placed in the opening 17 of the threaded socket 5 in the leading-in channel 29 was at the tightening of the cable clamp compressed between the spacer 3 and the bottom 35 in the opening of the threaded socket so that it assumed the stressed arc-shape shown in FIG. 3 in cross section. In this state, at least the inner cylinder face 23 in the center of the gasket 4 has been pushed to tight abutment against the cable 26, whereas the original groove 21 has changed shape and its volume has been increased, the elastomeric material of the gasket indeed being deformed but not compressed to any appreciable extent.

FIG. 4 shows the same cable clamp but now utilized for a relatively thick cable 36. In this case, the gasket 4 is spanning, seen in cross section, in an arch with far smaller curvature than in FIG. 3 in which the cable clamp was utilized for a relatively thin cable.

As it appears, the same gasket 4 can thus advantageously be utilized for both thin and thick cables. The cable clamp according to the invention is therefore well suited for reutilization as it can be utilized without problems for cables having diameter sizes within a predetermined interval. Thereby, the stock of cable clamps and gaskets can furthermore be reduced to a minimum.

As shown in FIG. 1, the transverse groove 7 in the head 2 of the nipple 1 leaves a relatively thin and therefore to some degree deformable end wall 37 at the external thread 19 of the nipple. On the outer side of this end wall 37 opposite of the groove is constructed a projecting radial rib 38 having e.g. a rectangular cross section.

In the head 6 of the socket 5 is constructed a corresponding radial groove 39 having a cross section matching the radial rib 38.

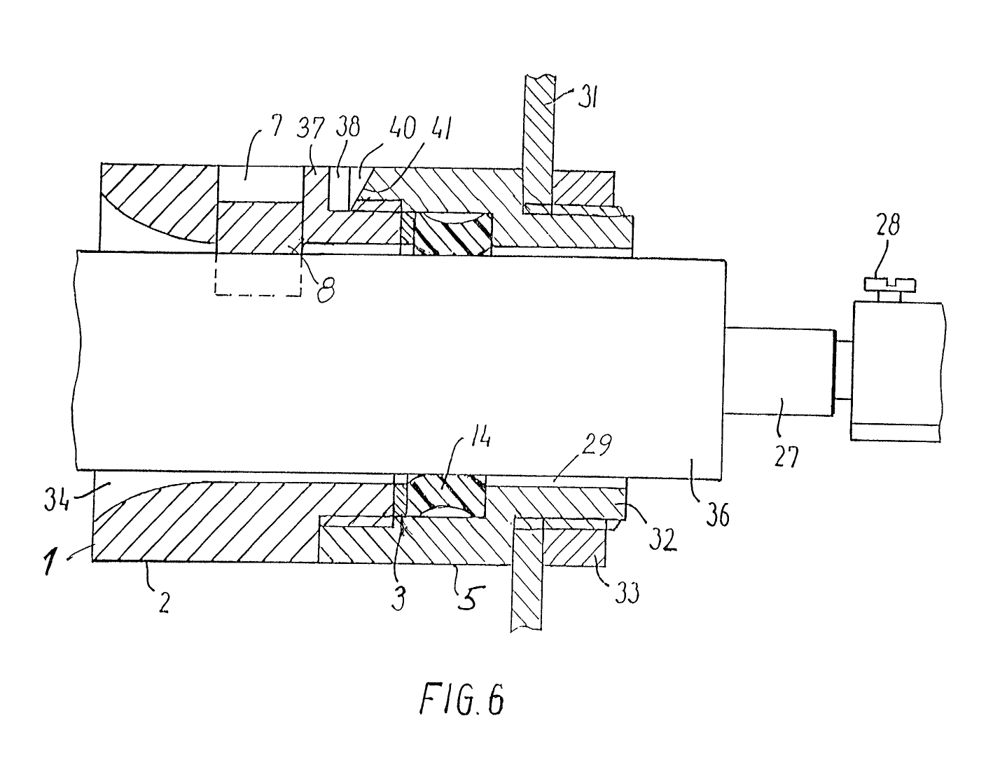

The purpose of the rib 38 and the groove 39 is illustrated in FIGS. 5 and 6 that show the same cable clamp as in FIG. 4 in two different screwing-together stages and in an angle displaced in relation to FIG. 4, the angular displacement of FIG. 6 is 90°.

In FIG. 5, the nipple 1 is screwed so far into the socket 5 that the radial rib 38 has first butted on the opposite end wall of the socket in order to then, during the continued rotation along this end wall, bend the thin end wall 37 on the head of the nipple so far in over the transverse groove 7 of this that there now no longer is room enough for the relieving clamp 8 to enter the transverse groove.

Thereby, the presence of the radial rib 38 effectively secures against the operator unintentionally pressing the relieving clamp 8 into the transverse groove 7 too soon at the risk of the connection thereby not being sufficiently tight and the arms 14 of the relieving clamp being damaged or broken because their hooks 15 cannot reach behind the radially projecting ribs 16 of the socket head 6, behind which ribs there is room for the hooks to enter without thereby deforming the arms of the relieving clamp.

In FIG. 6, the nipple 1 has now been screwed so far into the socket 5 that the radial rib 38 has snapped into the radial groove 39 of the socket with a normally audible click signaling the operator to stop the operation of screwing and then clamp the cable in the cable clamp by means of the relieving clamp which now easily can enter the transverse groove 7.

The same situation is also seen from above in FIG. 4 which clearly shows that the hooks 15 of the clamp are in their proper place behind the projecting ribs 16 of the socket head. The cable clamp is now tightened exactly so much that the connection has obtained the required tightness, and this is the case whether the cable inserted through the cable clamp is thick or thin.

The cable clamp according to the invention is thus generally applicable and well suited for reutilization.

In the case shown, the axial extent of the radial rib 38 corresponds to the lead of the thread 18; 19. The result of this is that the end faces of the nipple and the socket respectively will abut on each other when the radial ribs 38 of the nipple is engaging the radial groove 39 of the socket. Thereby, the cable clamp is strengthened.

The effect of the engagement of the projecting radial ribs 38 with the corresponding radial grooves 39 of the socket is that the nipple 1 now cannot be screwed either in or out of the socket 5. The nipple is locked in relation to the socket.

The radial rib and the radial groove thus together form an effective lock that prevents the operator from unintentionally tightening the cable clamp so tight that it is damaged or broken. At the same time, the lock also prevents the cable clamp form coming loose so that the connection gradually loses the required tightness.

Even if the relieving clamp has been removed from the transverse groove in the head of the nipple, the operator is however not able to screw the cable clamp apart just like that by himself once it is locked by the engagement of the radial rib with the radial groove.

In order to nevertheless be able to perform this sometimes necessary operation, the radial groove 39 is therefore designed with a depth which is larger than the axial extent of the radial rib 38. Behind the radial rib 38 is thereby formed in the locked state of the cable clamp a space 40 which in the shown case has an oblique back wall 41.

By means of e.g. a screwdriver (not shown) inserted into this space 40, the operator can now using the back wall 41 as rest easily twist the radial rib out of engagement with the radial groove and then screw the nipple out of the socket.

The lock of the cable clamp is described above and illustrated in the drawing as a projection in form of a rib and a recess in form of a groove respectively. It is to be noted that the projection and the recess within the scope of the invention can be of any expedient form. Thus the projection can for example merely be a pin on the thin end wall of the nipple and the recess a corresponding hole in the head of the socket.

Similarly, the radial rib can instead of being on the end wall of the nipple head be on the socket head, the radial groove then conversely being constructed in the end wall of the nipple head.

What is claimed is:

1. A cable clamp comprising a threaded nipple and a threaded socket that when connected define an axis and an axially extending leading-in channel for a cable, an annular gasket located intermediately in this channel and arranged to be compressed around the cable when the nipple and the socket are connected, and a relieving clamp for subsequently clamping the cable in the clamp, with the threaded nipple and the threaded socket each including a spanner head, with the head of the nipple being provided with a transverse groove for receiving the relieving clamp during assemblage, wherein the transverse groove includes an end wall situated in the normal plane of the axis on the point where the thread of the nipple begins, a projection extending from one of the end wall or socket head, and a projection receiving recess associated with the other of the end wall or socket head to receive the projection when the nipple and socket are connected.

2. The cable clamp of claim 1, wherein the projection extends from the end wall towards the socket head, and the socket head includes the recess.

3. The cable clamp of claim 1, wherein the projection extends from the socket head and the recess is present in the end wall.

4. The cable clamp of claim 1 which is configured and dimensioned for mounting in an opening of a wall for enveloping a cable inserted through the opening.

5. The cable clamp of claim 1 which is configured and dimensioned as a component of a cable connector.

6. The cable clamp of claim 1 wherein the nipple and socket are connected be screwing them together.

7. The cable clamp of claim 1, wherein the socket head includes two opposite mainly radially projecting flaps, and the relieving clamp includes two axially extending arms having inward pointing hooks that are adjacent the flaps when the relieving clamp engages the transverse groove of the nipple head and the projection engages the recess.

8. The cable clamp of claim 7, wherein the relieving clamp includes hooks and the socket head has openings only behind the flaps for allowing passage of the hooks crosswise of the socket head.

9. The cable clamp of claim 1, wherein the axial extent of the projection corresponds to the lead of the thread, and the recess has a depth that at least corresponds to the axial extent of the projection.

10. The cable clamp of claim 1, arranged in such a way that the nipple and socket heads are adjacent each other when the projection is engaging the recess.

11. The cable clamp of claim 1, wherein the projection is a radial rib and the recess is a corresponding radial groove.

12. The cable clamp of claim 11, wherein at least the radial rib has a mainly rectangular cross section.

13. The cable clamp of claim 11, wherein the radial groove of the socket head at least at the mouth in the periphery of the head has a larger axial extent than the radial rib of the nipple head.

14. The cable clamp of claim 1, wherein the projection is placed mainly directly opposite the transverse groove.

15. The cable clamp of claim 6, wherein the annular gasket is arranged to be compressed tightly around cables of various thicknesses when the nipple and the socket are screwed together.

16. The cable clamp of claim 15, wherein the annular gasket is mainly shaped as two funnels facing in opposite axial directions in relation to each other, the funnels passing into each other in the area of their smallest diameter.
